(19) United States
(12) Patent Application Publication
(10) Pub. No.: US 2020/0173898 A1
(43) Pub. Date: Jun. 4, 2020

(54) PROCESS FOR DETECTING ELECTROLYTE AND BIOMARKER ANALYTE LEVELS WITH FEMTOGRAM RESOLUTION IN IONIC SOLUTIONS

(71) Applicants: Selemani Seif, Edmonton (CA); Kenneth Cadien, Edmonton (CA); Thomas Thundat, Edmonton (CA)

(72) Inventors: Selemani Seif, Edmonton (CA); Kenneth Cadien, Edmonton (CA); Thomas Thundat, Edmonton (CA)

(21) Appl. No.: 16/204,303

(22) Filed: Nov. 29, 2018

(51) Int. Cl. G01N 5/02; G01N 29/036; G01G 3/13

(52) U.S. Cl. CPC G01N 5/02; G01N 29/036; G01N 2291/0426; G01N 2291/014; G01G 3/13

(57) ABSTRACT

A measurement probe system is provided that includes a housing, a Quartz Crystal Microbalance (QCM) mass sensor in the housing, a first cover and a second cover attached to the ends of the housing. A chamber is defined between the housing, the mass sensor, and the second cover. An electrical input in electrical communication with the mass sensor and an electrical output in electrical communication with the second cover are also included. The measurement probe system is used to detect nanoparticle levels in an ionic solution includes inputting an ionic solution sample into the chamber, applying a frequency from a signal generator to the QCM via the electrical input, detecting frequency noises with the second cover and transmitting those frequency noises to a frequency counter via the electrical output, and assessing the level of nanoparticles present in the sample based on the frequency measured by the frequency counter.

### FIELD OF THE INVENTION

The present invention generally to the field of biosensors, and more specifically to an ultrasensitive high Q-factor AT-cut quartz crystal microbalance (QCM) femtograms (fg or 10⁻¹⁵g) mass sensor and a method of using such a sensor to detect electrolyte and biomarker levels and femtogram frequency noises in ionic solutions such as blood or urine.

### BACKGROUND OF THE INVENTION

A number of medical conditions including electrolyte imbalance and cardiovascular or neurological events can be detected by sampling and testing bodily fluids such as urine and blood. Measuring levels of electrolytes and/or biomarkers, such as troponins, present in bodily fluids play a key role is diagnosis, prognosis, and risk stratification of patients.

Currently, many of these tests are done by taking a fluid sample from a patient and sending it to a laboratory for testing. Results from these laboratory tests often take many hours to obtain given the test equipment and procedures used and/or the backlog of samples waiting to be tested, prolonging diagnosis and treatment of potentially life-threatening medical conditions. Additionally, these laboratory tests cannot provide real time information, making it difficult to assess whether a patient is responding to a course of treatment as intended.

Point of care (POC) tests can drastically increase patients' chances of, fast diagnosis, successful treatment, survival because they can be administered much more quickly than the, lab tests. However, existing POC devices do not have the ability to monitor the rise and fall of electrolyte or troponin levels of a patient in real time. Additionally, most diagnostic POC devices are limited to picogram sensitivity, failing to detect medical conditions in their early stages, and generally they also take hours to provide results.

Ultrasensitive mass sensing devices, such as nanoelectromechanical systems (NEMS) and micro cantilevers that include a family of quartz crystal microbalance (QCM) and carbon nanotube (CNT), have shown a higher mass sensitivity and high throughput analysis capable of detecting a specific bioreceptor to which a target antibody or antigen binds. Upon binding of antigen/antibody targets on the sensor, the change in mass is related to a measurable output frequency in relation to the binding species such as a single cell, a molecule, a virus, a troponin, or a bacterium. These micro-organisms are in the pg to fg scale weight regime and can easily be detected by matching their masses with frequency change using devices with high mass resolutions in the pg to fg regimes. Although many patents based on CNT, micro-cantilevers, MEMS, NEMS and QCM have claimed to measure pg, fg, attogram (10⁻¹⁸ g or ag), and zeptogram (zg or 10⁻²¹ g), the technology to measure mass beyond pg in real time does not exist due to difficulty in fabrication and reproduction of the same vices and results.

A QCM mass sensor is a simple, cost-effective, high-resolution mass-sensing technique used to study properties of monolayer surfaces deposited on quartz wafers such as molecules, bacteria, antibody-antigen interaction, single cells, proteins, and thin films of polymers. A QCM sensors use a phenomenon in which when the mass of the electrode increases due to corrosion or mass deposited, the oscillation frequency of the quartz oscillator is reduced according to the amount of corrosion. The QCM sensor is capable of detecting a change in oscillation frequency of a quartz oscillator with a very high degree of sensitivity, and is capable of performing measurement in a short period of time compared to that of a sensor that uses other measuring methods, such as a coupon method. Therefore, QCM sensors are often adopted as an environment measuring device. QCM sensors are comparatively inexpensive, easy to fabricate and manufacture, and commercially available in the market. Commercial QCM sensors have the ability to measure mass to approximately 1×10⁻⁹ to 10⁻¹² g/cm².

QCM sensors are also capable of measuring mass and energy dissipation properties of surface functionalized bio materials while simultaneously carrying out electrochemistry studies on solution species. Sauerbrey was the first to recognize the potential usefulness of the QCM technology and demonstrated the mass sensitivity nature towards frequency changes at the surface at QCM electrodes. Sauerbrey derived the equation which relates the mass change per unit area at the QCM electrode surface to the observed change in oscillation frequency of the crystal as shown in the following equation:

K=2*f²/\sqrt{ρμ}=2.26*10⁻⁶f²Hz·cm²/g,

where K is the mass sensitivity coefficient, ρ=2.648g/cm³, is the density of quartz crystal, and μ=2.947*10¹¹ g/cm·s², is the shear modulus of quartz crystal. By using the Sauerbrey's mass sensitivity coefficient, it has been shown that it is possible to use AT-cut QCM to measure mass of thin film functionalized on quartz disk to 2.7 fg/cm² (L. Rodriguez-Pardo, J. F. Rodriguez, C. Gabrielli, H. Perrot. Sensitivity, noise, and resolution in QCM sensors in liquid media. IEEE Sensors Journal. 5, 6 (2005)).

After Sauerbrey derived an important equation which relates mass of a substrate added on a quartz disk to frequency shift, Allan was the next to derive an equation which represented frequency stability and noise arising from the driving oscillator circuit in the time domain in less than 10 seconds (M. J. Moure, P. Rodiz, D. Valdes, L. F. Rodriguez-Padro, and J. Farina. An FPGA based system for the measurement of frequency noise and resolution of QCM sensors. Latin American Applied Research. 37, 30 (2007)).

The institute of Electrical and Electronics Engineers (IEEE) has recognized Allan's equation and called it the Allan variance (IEEE Std. 1139, 1999) with the expression: σ=(1*10⁻⁷)/Q, where σ is the Allan variance and Q is the Q-factor of an AT-cut quartz disk. In embodiments of this invention, both Sauerbrey and Allan deviation equation is applied, and it has been shown that if the mass sensitivity coefficient of AT-cut quartz disk is known, it is possible to estimate mass resolution using as measured Q-factors. Since the Allan deviation σ(τ), can be estimated using σ=10⁻⁷/Q; then, the detection limit Δf(τ) can be calculated using the equation, σ(τ)*f(τ)=Δf(τ). The mass resolution on the surface of the active electrode area can be calculated by taking the ratio of detection limit Δf(τ) to mass sensitivity coefficient (K). It has also been reported in the literature that the typical absolute dissipation (ΔD) values of crystals oscillating in air and water are about 1*10⁻⁵ and 3.5*10⁻⁴, respectively, the ΔD reported in literature upon exchange of the protein on a gold electrode is approximately 1*10⁻⁶ (F. Hook, M. Rodahl, P. Brzezinski, and B. Kasemo. Energy dissipation kinetics for protein and antibody-antigen adsorption under shear oscillation on a quartz crystal microbalance. Langmuir 14, (2998), 729-734).

One of the current challenges is to make a portable diagnostic point of care device to detect not only femtogram mass, antigen, antibody, but also salt level, before cardiovascular or neurological infections. POC devices that are able to detect levels below single pg levels could open up new business opportunities globally in material sciences, life sciences, and in medical and diagnostic point of care, and could save the lives of many people by detecting the potentially life-threatening medical conditions and events early. Such POC devices require improved analytical sensitivity to detect the lower clinically relevant concentrations of indicators of medical conditions or events. Research into increasingly sophisticated POC platforms potentially permits the development of more advanced systems using novel signal transduction platforms, modified surfaces, microfluidic and detection systems. The trend towards miniaturization (nano and micro) complicates the process in terms of the ancillary components required but also introduces challenges for the type and quality of sensors developed for such applications. Therefore, the introduction of nanoscale mass sensing devices such as QCM, micro-cantilevers, carbon nanotube (CBN), and MEMS with higher mass sensitivity and detection of fewer than 10 seconds may provide a solution to the current problems. These devices depend only on the frequency shift and no photodetector or microcentrifuge is needed; because the change in frequency is directly proportional to the mass of molecules present.

The ability to measure frequency noises equivalent to femtogram mass and Na+ ions from 0.100 M/L to 0.155 M/L in the clear urine or saline solution (NaCl), would make it possible to develop the technology to detect normal and abnormal salt level, a single virus, a bacterium or blood Cardiac Troponin level. Technology like this needs a device to generate stable frequency noises approximately from 10⁻⁸ to 10⁻¹² through the electrolyte solution in contact with the surface of the mass sensor without using a mechanical force, a phenomenon which uses AC-electrodynamic force to move fluids and charged ions in microfluidic devices^{1, 2, 3}. The potential advantages include the nom-moving mechanical parts, precise high velocity fluid flow on the electrode layer^{4,5,6}, ease to fabricate, and low power consumption. Recent studies using NaCl_{7,8,9} solution have shown that several electrolytes stabilize the velocity of ions on the electrode surface, from non-linear (when the frequency is between 1 to 100 KHz) to approximately linear curve as the frequency increases (above 1.0 MHz). Following those studies, it has also been reported that blood components such as serum have an impedance that steadily decreases with the increase of frequency up to 100 kHz and flatten¹⁰ out after 1.0 MHz to produce stable frequency between 1 and 10 MHz. The same effect has been reported from analysis of normal and diabetic blood where the relaxation time¹¹ dropped from 2.1*10⁻⁵ s, and flattened rapidly at 1.26*10⁻⁷ s, after 1.25 MHz. This effect was also observed by measuring output voltage in between 1 and 2 MHz using 2 M and 5 M of NaCl solution¹². The results showed that the output voltage signals increased as NaCl concentrations increased and the frequency started to flatterns and stabilizes slowly after transitioning from 1 to 2 MHz.

Therefore, there is a need for cost-effective and sensitive diagnostic equipment and a process to detect electrolyte and analytes, such as troponin at femtogram levels in ionic solutions such as blood or urine for more rapid interventions. There further exists a need for such detection to be continuous so as to detect changes in patient condition without resort sending samples for laboratory testing and then awaiting results.

### SUMMARY OF THE INVENTION

A measurement probe system is provided that includes a housing, a Quartz Crystal Microbalance (QCM) mass sensor disposed within the housing, a first cover and a second cover attached to the housing at the ends of the housing. A chamber that is configured to receive a fluid sample is defined between the housing, the mass sensor, and the second cover. The measurement probe system also includes an electrical input in electrical communication the mass sensor and an electrical output in electrical communication with the second cover.

A method of using the measurement probe system to detect nanoparticle levels in an ionic solution is also provided. The method includes inputting a sample of the ionic solution into the chamber, applying a frequency from a signal generator connected to the QCM mass sensor via the electrical input when the mass sensor is in contact with the sample in the chamber, detecting frequency noises with the second cover and transmitting those frequency noises from the second cover to a frequency counter via the electrical output, and assessing the level of nanoparticles present in the sample of ionic solution based on the frequency measured by the frequency counter.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration showing the system probe with input and output coaxial cables, the input coaxial cable is connected directly to the ring electrode of the sensor; the output coaxial cable is connected to the brass electrode.

FIG. 2 is an illustration showing the measurement of the Q-factors using impedance meter, the input signal is via the ring electrode on the upper side while the bottom side is grounded.

FIG. 3 is a curve showing the measured frequency noise stability at the different input voltage.

FIG. 4 is a curve showing the measured Q-factors as a function frequency.

FIG. 5 is a curve which shows the calculated detection limit of the QCM mass sensor as a function of frequencies.

FIG. 6 is a curve which shows the calculated mass resolution of the QCM mass sensor as a function of frequencies.

FIG. 7A is a curve showing the measured frequency noises in deionized water.

FIG. 7B is a curve which shows the measured frequency noises of 0.100 M of Na+0 ions in deionized water.

FIG. 8 is a curve with the black line showing the measured frequency noises in the air while the green curve is the measured frequency noises of 0.120 M of Na+ ions in deionized water.

FIG. 9A is a curve with a black line which shows the measured frequency noises in 0.130 M of Na+ ions concentration in deionized water, the red curve is the measured frequency noises of 0.140 M of Na+ ions in deionized water.

FIG. 9B is a curve with a green line which shows the measured frequency noises of 0.150 M of Na+ ions in deionized water while the blue curve is the measured frequency noises of 0.155 M of Na+ ions in deionized water.

FIG. 10A is a curve showing the measured frequency noises of lower Mg++ ion level in deionized water same as that in clear urine or blood.

FIG. 10B is a curve showing the measured frequency noises of higher Mg++ ion level in deionized water same as that in clear urine or blood.

FIG. 11A is a curve showing the measured frequency noises of lower Ca++ ion level in deionized water same as that in clear urine or blood.

FIG. 11B is a curve showing the measured frequency noises of higher Ca++ ion level in deionized water same as that in clear urine or blood.

FIG. 12A is a curve showing the measured frequency noises of lower K+ ion level in deionized water same as that in clear urine or blood.

FIG. 12B is a curve showing the measured frequency noises of higher K++ ion level in deionized water same as that in clear urine blood.

FIG. 13 is a curve which shows the measured frequency noises of Cardiac Troponin dissolved in 10 mL, 100 mL, and 1000 mL.

### DESCRIPTION OF THE INVENTION

The present invention has utility as a probe and a process of using such a probe to detect electrolyte and biomarker levels and femtogram frequency noises in ionic solutions such as blood or urine. Embodiments of the probe include an ultrasensitive high Q-factor Quartz Crystal Microbalance (QCM) femtogram mass sensor. The QCM mass sensor generates frequency noises capable of detecting abnormal and normal electrolyte and biomarker levels in ionic solutions. The probe is used to measure frequency noises arising from nanoparticles suspended in ionic solutions. The nanoparticles may be electrolytes, bacteria, virus, antivirus, molecules, or cardiac troponin.

Electrolyte velocity, relaxation time, and frequency noises tend to stabilize between 1 and 2 MHz when electrolyte ions move on the surface of the electrode. Accordingly, the ultrasensitive QCM mass sensor¹³ is designed to resonate at 1.694 MHz. This sensor is very sensitive and is used to produce and detect very tiny frequency noises between 10⁻⁸ and 10⁻¹⁰ MHz. According to embodiments, electrolyte and biomarker concentrations are determined using measured frequency noises with the best aging rates¹⁴ of 10⁻¹⁰ MHz. Thus, an extension of QCM mass sensor technology¹⁵⁻²⁰ to measure frequency noises equivalent to femtogram or electrolyte or biomarker level in ionic solutions is provided. This AT-cut QCM mass sensor is significantly more sensitive than any available system in the market. Here a QCM mass sensor is used over Microelectromechanical Systems (MEMS), Micro-Cantilevers, and Carbon Nanotube (CNT)²¹⁻³⁴ because it is cost-effective, easy to fabricate and reproduce, and has the limitation to measure mass from 10⁻⁹ to 10⁻¹⁰ gm/cm², however it will be understood that the other sensor types can also be used. The present invention has the capability to measure frequency noises equivalent to femtogram; thus being able to measure normal and abnormal electrolyte and up to 10⁻¹³ gm/1000 mL of Cardiac Troponin in ionic solutions.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

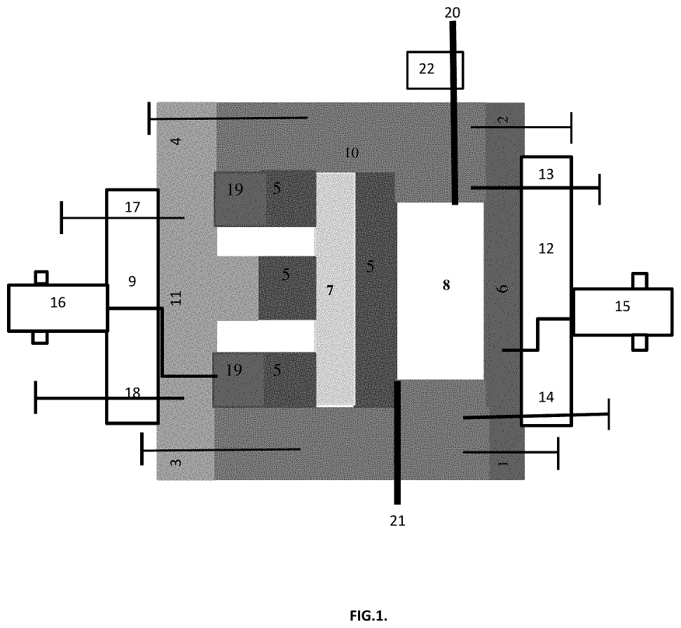

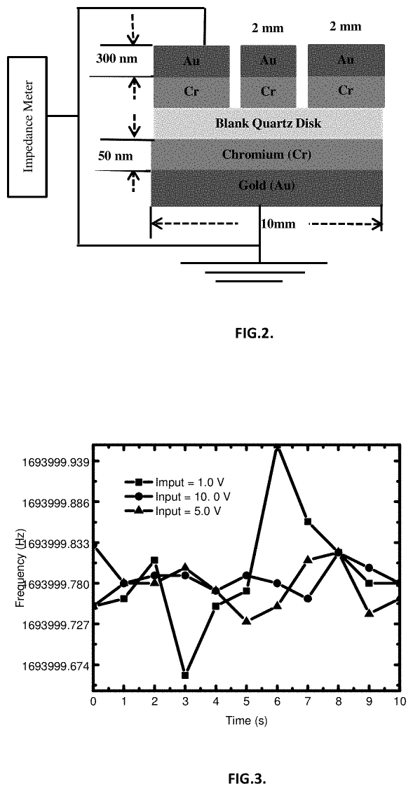

FIG. 1 shows a schematic drawing of a probe 100 according to embodiments of the present disclosure. Central to the probe 100 is an ultrasensitive high Q-factor Quartz Crystal Microbalance (QCM) mass sensor including a blank quartz disk 107 and gold layers 105 positioned on a top and bottom side of the blank quartz disk 7. Between the blank quartz disk 107 and the gold layers 105 there is a chromium adhesive layer 125, which is shown in FIG. 2. Further details of the ultrasensitive high Q-factor Quartz Crystal Microbalance (QCM) mass sensor are provided in U.S. patent application Ser. No. 15/810,348, filed on Nov. 13, 2017, which is hereby incorporated by reference.

Referring again to FIG. 1, the QCM is disposed within a housing 110 at a first end. According to embodiments, the housing 110 is cylindrical. According to further embodiments, the housing 110 is made of Teflon. Also, within the housing 110, disposed on and in electrical communication with the gold layer 105 at the first end of the QCM is a circular brass ring 119. Both ends of the housing 110 are enclosed by a cover 111, 106. According to embodiments, the cover 111 at the first end of the housing 110 is T-shaped and is made of Teflon. As shown, the T-shaped cover 111 is in contact with the housing 110, the circular brass ring 119, and the gold layer 105 at the first end of the QCM. The first cover 111 is secured to the housing 110 by any suitable fastener, such as screws 103, 104 as shown in FIG. 1. According to embodiments, the cover 106 at the second end of the housing 110 is a disk, which may be made out of brass. The second cover 106 is secured to the housing 110 by any suitable fastener, such as screws 101, 102 as shown in FIG. 1.

As shown in FIG. 1, the housing 110, the gold layer 105 at the second end of the QCM, and the second cover 106 define a chamber 108 within the housing configured to be filled with ionic solutions containing electrolytes or biomarkers in different concentrations. According to embodiments, the chamber 108 is a 0.1 mL cylindrical chamber. The chamber 108 has an inlet 120 through the housing 110 and an outlet 121 through the housing 110. According to embodiments, the probe system 100 can be connected to a Foley catheter tube through the input flow channel 120 through the housing 110 into the chamber 108. The outlet 121 of the chamber 108 through the housing 110 connects to a collecting bag, according to embodiments. As shown in FIG. 1, the inlet 120 may include a filter 122. The filter 122 separates hydrophobic and hydrophilic compounds from the ionic solution. The filter 122 may be installed on the tube of the Foley catheter at the inlet 120 of the chamber 108, such that the ionic solution is filtered before entering the chamber 108.

Disposed on the outside of the first cover 111 is a first base support 109, which is attached to the first cover 111 and/or the housing 110 by screws 117, 118, or any other suitable fasteners. A male part 116 of a coaxial cable is connected to the first base support 109. A wire 126 electrically connects the male part 116 of the coaxial cable to the brass electrode 119. According to embodiments, the wire 126 is copper.

Disposed on the outside of the second cover 106 us a second base support 112, which is attached to the second end of the housing 110 by screws 113, 114, or any other suitable fasteners. An output coaxial cable 115 is connected to the second base support 112. A wire 128 electrically connects the output coaxial cable 115 to the second cover 106. According to embodiments, the wire 128 is copper,

In operation, the QCM mass sensor is placed at the top of chamber 108 where the full coated gold electrode 105 sits on the surface of the ionic solution that is fed into the chamber 108 through the input 120. The circular ring electrode 119 of the QCM mass sensor is exposed on the top side. Input signals are applied from a female terminal coaxial cable from a signal generator, such as a Tektronix AFG2021 (not shown), to the input male coaxial cable terminal 116 connected directly to the QCM mass sensor. The coaxial cable 116 receives the input signal from the signal generator via the wire 126 which connects directly to the QCM mass sensor through the brass ring electrode 119. The QCM mass sensor produces frequency noises via the ionic solution, and the suspended nanoparticles, or molecules, are measured as output frequency noises from the second cover 106, which may be a brass disk. The output signal from the output coaxial cable 115, which is connected to the second cover 106 via wire 128, is measured using a frequency counter, such as Tektronix FCA3000 (not shown) via a female coaxial cable terminal.

By using the invented probe system, a frequency counter and a signal generator, it is possible to measurer signal noises related to electrolyte and biomarker levels in ionic solutions, such as bodily fluids, over the course of extended periods of time, for example 24 hours. Also, it is possible to measure other metabolic products seen in unclear urine and whole blood such as urea, blood cells, antigens, antibodies, and lipids by using special concentrated sodium chloride solution where the measurable parameters are the rise time pulses.

According to embodiments, the probe system can be miniaturized to neglect the use of the signal generator and frequency counter, thus being able to develop a portable system which can be used in Doctors' office, hospitals, laboratories, home care, and long-term care facilities. The probe system can be easily miniaturized using Field Programmable Get Array (FPGA). The FPGA can be programmed to translate the measured frequency noises to their equivalent electrolyte or biomarker level measured in ionic solutions. The presently disclosed probe system is capable of measuring pulses related to frequency noises from 10⁻⁸ to 10⁻¹² MHz, thereby enabling users to analyze individual molecules, electrolytes, biomarkers, hormones, antibodies, bacterial, virus, Cardiac Troponin, and blood cells in concentrated ionic solutions, and determine their corresponding selectivity noises depending on the measurable rise time pulses.

An initial part of the measurement includes the Q-factors measurements of the QCM. The highest -factor is 765682 and the calculated mass in the air at the same resonance frequency (1.694 MHz), is 1.25*10⁻¹⁵ gm/cm². Next, the frequency noises are related to the electrolytes in concentrated saline solution using the probe. The measured frequency noises from 10⁻⁸ to 10⁻¹⁰ MHz, represent the concentrations of electrolyte level and femtogram mass or (10⁻¹⁵ gm) in an ionic solution. This probe can also detect frequency noises equivalent to Cardiac Troponin to 2.268*1.0⁻¹³ gm/1000 mL.

The probe equipped with an ultrasensitive QCM mass sensor is capable of measuring normal and abnormal electrolyte and biomarker levels in deionized water same as that in clear urine by measuring the frequency noises related to Potassium, Calcium, Magnesium and Sodium. The probe also detects different concentrations of cardiac troponin level in a standardized saline solution with other blood electrolytes having Na+ ions, approximately 0.155 M/L.

The probe measures the frequency change, Δf, as the concentrations of electrolytes in ionic solutions change. An applied AC electric field from the signal generator to QCM mass sensor is used to move charged ions and fluid contents back and forth, causing, Δf, and mass change, Δm, on the surface of the sensor as discussed by Sauerbrey³⁵. Other factors which affect, Δf, in the solution medium are the compression effect due to changes in pressure, Δfₚ, the interaction of the smooth surface of a vibrating QCM mass sensor with a viscous medium, Δf_{γ}, the roughness effect due to the interaction of the rough surface with the fluid³⁶, Δfᵣ, and the change due to viscosity and density variations of the immersion solution Δf₇₂ . Therefore, the measured frequency noises in the solution medium are: Δf=Δfₘ+Δfp+Δf_{η}+Δfᵣ+Δf_{γ}. The following are the basic symbols used in equations which show the relationship between the measured, Δf, resonant frequency (f₀), the viscosity of fluid medium (η), density of fluid (ρ₁), the density of blank quartz disk (ρ_{q}) and the shear modulus of the crystal (μ_{q}).

Starting with Sauerbrey, the measured frequency change, Δf, as a function of the mass change, Δm, is shown as:

$$Δ f = \frac{2 {f}_{0}^{2}}{A \sqrt{{μ}_{q} {ρ}_{q}}} Δ m , \qquad ( 1 )$$

where, A, is the area of the Gold electrode surface. Equation (1) reduces to a linear sensitivity factor, Cf, as shown in equation (2):

$$Δ f = \frac{- Cf Δ m}{A} . \qquad ( 2 )$$

The Cf is a fundamental property of the QCM crystal, which is equal to 56.6 Hz μg⁻¹ cm², and can be solved by equation (3):

$$Cf = \frac{2 {f}_{0}^{2}}{\sqrt{{μ}_{q} {ρ}_{q}}} . \qquad ( 3 )$$

The equations 1, 2, and 3, are strictly applicable to uniform, rigid, thin-film deposits on the crystal surface. Another valid form of mass adsorption related to frequency change and mass change is shown in equation (4):

$$\frac{Δ f}{f} = \frac{Δ m}{m} , \qquad ( 4 )$$

where, m, is the known mass gold electrode layer. From this relationship it can be seen that the change in frequency, Δf, is proportional to the change in mass, Δm, on the crystal surface. Kanazawa and Gordon³⁷ used this concept in liquid solutions and related the mass deposited to the liquid viscosity and density as shown in equation (5):

$$Δ f = {f}_{0}^{3 / 2} [ \frac{{ρ}_{l} {η}_{l}}{π {ρ}_{q} {μ}_{q }} ] . \qquad ( 5 )$$

The mass effect, Δfₘ, and the viscous effect, Δf_{η}, are the primary variable factors considered measured as a function of Δf during our experimentation. Since the measurable Δf using equation 5 includes all five factors, equation (4) can be used to estimate Δm of interacting particles with an electrode layer having a known mass (m). Therefore, if the Δf is measured in presence of solution medium, the effects from other factors encountered in equation (5) are also measured collectively and, equation (4) can be used to calculate Δm if the mass (m) of the Gold electrode on the surface of the crystal is known. To achieve these goals, we have designed a cylindrical chamber which uses NaCl solution to conduct an AC electrical signal noises from the QCM mass sensor to the probe's output male coaxial cable connected to a brass electrode.

### EXAMPLES

Before doing the Q-factor measurements using impedance meter, the frequency counter and the signal generator are calibrated using different input voltage to find the maximum input voltage where the frequency noises stable. The input parameters from the signal generator (Tekronix AFG2021) are varied from 1.0 V, 5.0 V and 10.0 V at 1.694 MHz, and the output frequency noises are then measured using a frequency counter (Tektronic FCA3000) as shown in FIG. 2. FIG. 3 is a graph showing the frequency noise stability at the different input voltages. The frequency noises became more stable at 10.0V and the maximum detectable noise is 10⁻¹⁰ MHz. The measured frequency noise when the input voltage is 1.0 V, is 10⁻⁶ MHz.

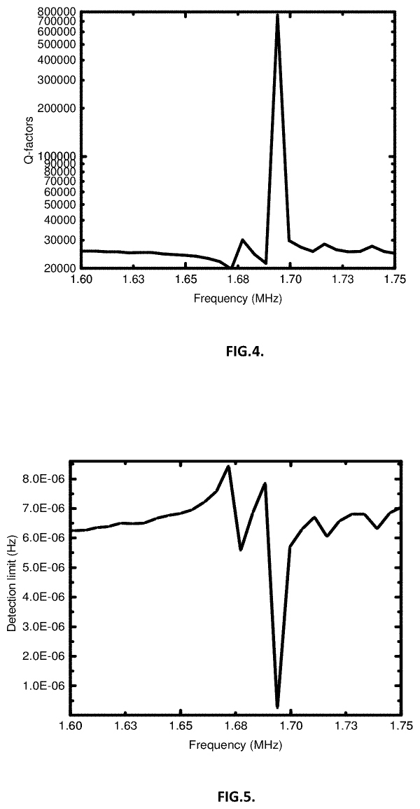

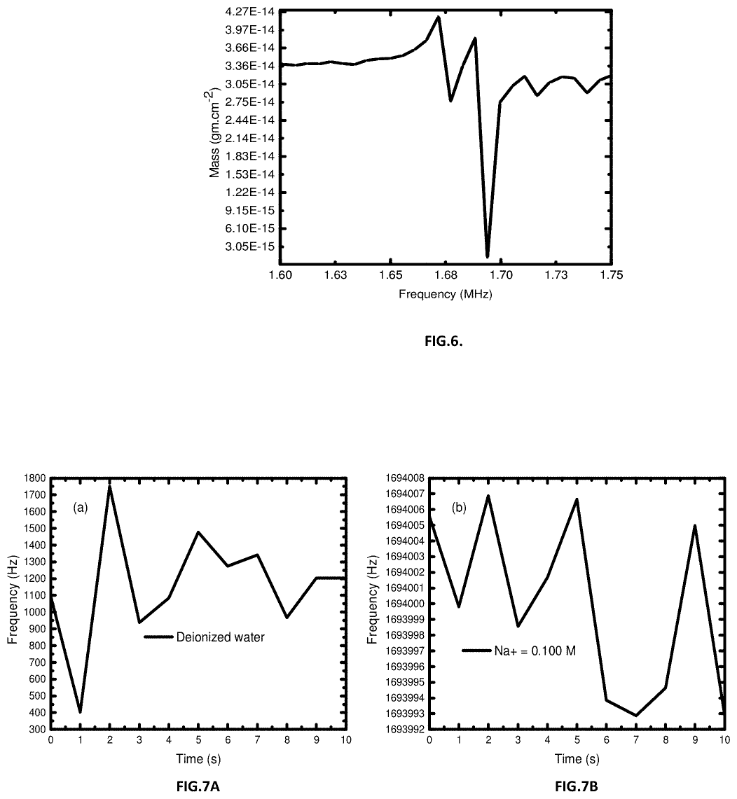

The Q-factors are then measured as a function of frequencies from 1.60 to 1.75 MHz at 10.0V. The highest Q-factor is 765682 at 1.697 MHz, and the lowest Q-factors are around 30,000 at both 1.68 MHz and 1.73 MHz, as shown in FIG. 4. The Q-factors and frequencies are then substituted to σ(τ)*f(τ)=Δf(τ), where Δf(τ) is detection frequency and σ(τ) is Allan deviation^{38, 39}. The Allan deviation is calculated using σ(τ)=10⁻⁷/Q, where Q is the measured Q-factors from 1.60 to 1.75 MHz, The mass sensitivity coefficient (K) is calculated using the measured frequencies between 1.60 and 1.75 MHz by substituting the frequency to the Sauerbrey mass sensitivity coefficient; K=2f²/\sqrt{ρμ}=2.26×10⁻⁶ f² Hz·cm²/gm, where the symbol ρ is the density of quartz crystal which is 2.648 g/cm³, and μ is the shear modulus of quartz crystal, which is 2.947×10¹¹ g/cm·s². The calculated σ(τ) in the same frequency range was then used to calculate Δf(τ), the results are depicted in FIG. 5, which shows that the highest Δf(τ) is (2.5*10⁻⁸ MHz) at 1.69 MHz. The ratio of Δf(τ) to K is reported as mass resolution as shown in FIG. 6.

FIG. 7A is a curve showing the frequency noises measured in deionized water, the frequency shift is from 1 KHz to 1.75 KHz and the frequency change, Δf, is 0.75 KHz. FIG. 7B is the measured frequency noises when Na+ ions concentration is 0.100 M, the measured frequency noises shifted from 1.69399241 to 1.69399248 MHz and the frequency change, Δf, is 7*10⁻⁸ MHz as shown in the curve. FIG. 8 shows the frequency noises measured in the air and in the 0.120 M of Na+ ions concentration. The measured frequency noises in the presence of 0.120 M shift from 1.693956482 to 1.69395684 MHz and the frequency change is 2*10⁻⁸ MHz as shown in the curve. The measured frequency noises in the air shift from 1.6974567567 to 1.6974567569 MHz and the frequency change, Δf, is 2*10⁻¹⁰ MHz as seen in the curve.

Table 1 is the equivalent Sodium ions concentration (Na+) in clear urine prepared from deionized water. The samples for frequency noise measurements are prepared from NaCl crystals dissolved in deionized water. The concentration of Na+ (0.00345 M) remains constant and the amount of deionized water is varied from 34 mL to 22.25 mL to make the concentration of Na+ ions in deionized water the same as the normal Na+ ions in urine or blood; which is equivalent to 0.100 M/L to 0.155 M/L, respectively, For sample number 1, the moles (M) of NaCl dissolved in deionized water are calculated as 0.5 g/58 gm=0.0086 M. Since the 0.0086 M is for both Na+ and Cl⁻ ions in the solution, a mole ratio for each ion is used to obtain the exact moles of Na+ and Cl⁻ ions. For Na⁺ ions, the mole ratio is (23/58)*0.0086=0.00345 M. The urine equivalent Na+ ions concentration (say 0.100 M/L=0.100 M/1000 mL) is known, so the equivalent volume of deionized water for (0.00345) is calculated as (1000 mL*0.00345 M)/0.100 M=34 mL. The same process is repeated for samples number 2 to 9. The results are depicted in Table 1.

TABLE 1
Prepared urine-equivalent Sodium ions in deionized water.

| | Mass | Moles of Na+ | Deionized water | Urine equivalent |
|---|---|---|---|---|
| Samples | (gm) | ions (M) | (mL) | (M/L) |
| 1 | 0.5 | 0.00345 | 34.00 | 0.100 |
| 2 | 0.5 | 0.00345 | 28.48 | 0.120 |
| 3 | 0.5 | 0.00345 | 27.60 | 0.125 |
| 4 | 0.5 | 0.00345 | 26.54 | 0.130 |
| 5 | 0.5 | 0.00345 | 25.00 | 0.135 |
| 6 | 0.5 | 0.00345 | 24.64 | 0.140 |
| 7 | 0.5 | 0.00345 | 23.79 | 0.145 |
| 8 | 0.5 | 0.00345 | 23.00 | 0.150 |
| 9 | 0.5 | 0.00345 | 22.25 | 0.155 |

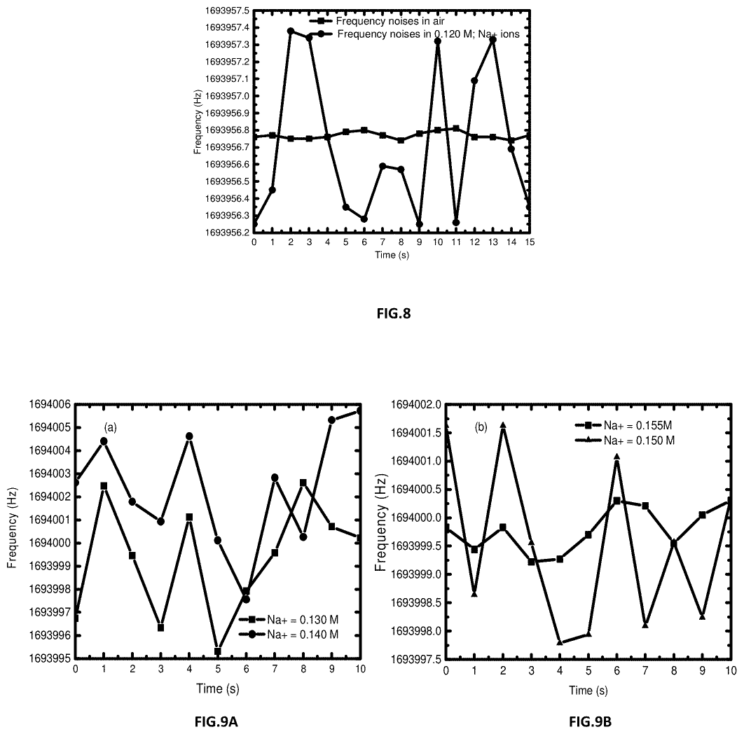

FIG. 9A is a curve showing the measured frequency noises when Na+ ions concentration increases to 0.130 M, the measured frequency noises shift from 1.693997972 to 1.693997979 MHz and the frequency change, Δf, is 7*10⁻⁹ MHz. When the Na+ ions concentration is 0.140 M, the measured frequency noises shift from 1.694001574 to 1.694001574 MHz and the frequency change, Δf, is 3*10⁻⁹ MHz. FIG. 9B shows the measured frequency noises when the Na+ ions concentration is 0.150 and 0.155 M. The measured frequency noises for 0.150 M shift from 1.6939998992 to 1.6939998998 MHz and the frequency change, Δf, is 4*10⁻¹⁰ MHz. In 0.155 M, the frequency noises shift from 1.6939996674 to 1.6939996676 MHz and the frequency change, Δf, is 2*10⁻¹⁰ MHz.

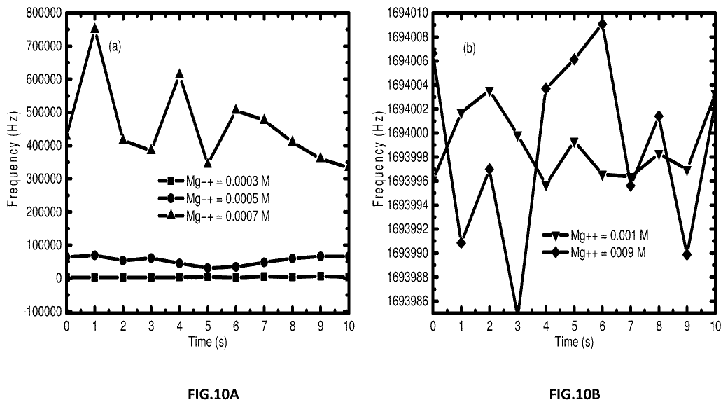

FIG. 10A is a curve showing the measured frequency noises of a solution with low Magnesium ion level from 0.0003 to 0.0007 M as seen in in Table 2. Table 2 shows the equivalent Magnesium ions concentration (Mg++) in clear urine prepared from deionized water. Samples 1 to 5 are prepared from MgCl₂.6H₂O crystals dissolved in deionized water. The concentrations of Mg++ ions in deionized are the same as the normal Mg++ ions in urine. During sample preparation, the concentration of Mg++ (0.0000093 M) ions are kept constant and the amount of deionized water is varied from 9.666 mL to 2.900 mL; which is equivalent to 0.0003 M/L to 0.0010 M/L, respectively. For sample number 1, the moles (M) of MgCl₂.6H₂O dissolved in deionized water are calculated as 0.005 g/203.3 gm=0.0000246 M. Since the 0.0000246 M is for all ions in the solution made of MgCl₂. 6H₂O A mole ratio is used for Mg++ ions as (24/203.3)*0.0000246=0.0000029 M. Given the urine equivalent Mg++ ions concentration (say 0.0003 M/L=0.0003 M/1000 mL), then the equivalent volume of deionized water for (0.0000029) is calculated as (1000 mL*0.0000029 M)/0.0003 M=9.666 mL. The same process is repeated for samples number 2 to 5. The results are depicted in Table 2.

TABLE 2
Prepared urine-equivalent Magnesium ions in deionized water.

| | Mass | Moles of Mg++ | Deionized water | Urine equivalent |
|---|---|---|---|---|
| Samples | (gm) | ions (M) | (mL) | (M/L) |
| 1 | 0.005 | 0.000003 | 9.666 | 0.0003 |
| 2 | 0.005 | 0.000003 | 5.800 | 0.0005 |
| 3 | 0.005 | 0.000003 | 4.143 | 0.0007 |
| 4 | 0.005 | 0.000003 | 3.222 | 0.0009 |
| 5 | 0.005 | 0.000003 | 2.900 | 0.0010 |

As shown in FIG. 10A, the measured frequency change, Δf, when the concentration is 0.0003 M is 25 KHZ. As the concentrations increase to 0.0005 M, the measured frequency noises stabilize to 50 KHz. When more concentration of Mg++ ions increase to 0.0007 M, the measured frequency noises stabilize to 200 KHz, between 400 and 600 KHz. FIG. 10B shows the curves of measured frequency noises when Magnesium ions concentration is 0.0009 M or 0.001 M. When the Mg++ ions concentration is 0.0009 M, the measured frequency peaks stabilize between 1.693986 and 1.694206 MHz, the measured frequency change, Δf, is 2.2*10⁻⁴ MHz. The measured frequency noises stabilize between 1.693896 and 1.693997 MHz when the Mg++ ions concentration increases to 0.001 M. The frequency change, Δf, is 1.01*10⁻⁴ MHz.

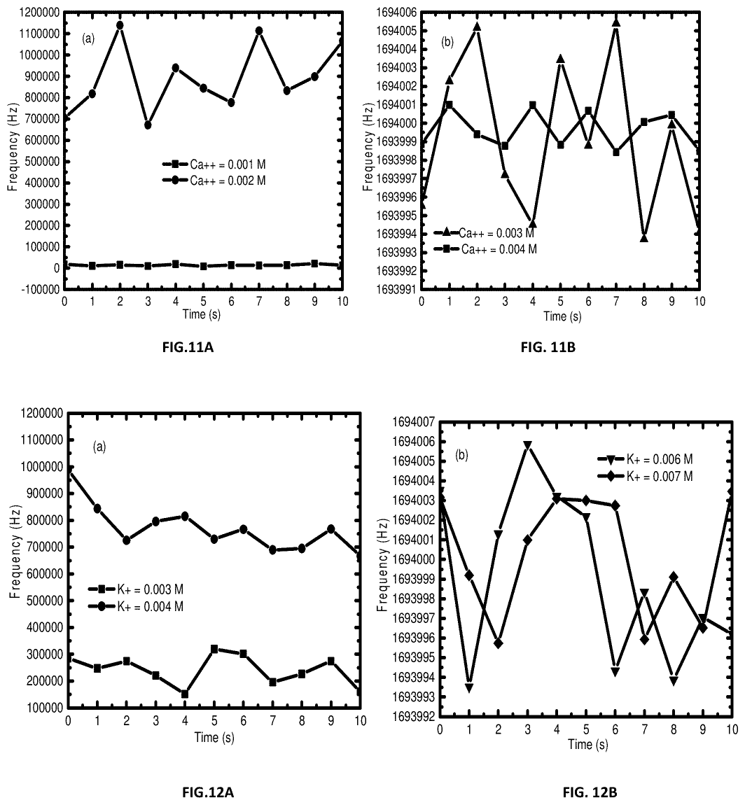

FIGS. 11A and 11B are curves showing the measured frequency noises of a solution with a low Calcium ion level of 0.001 M, 0.002 M, and higher Calcium ions concentration of 0.003 M, 0.004 M as shown in Table 3. Table 3 shows the equivalent Calcium ions concentration (Ca++) in dear urine prepared from deionized water. Samples 1 to 5 are prepared from NaCl crystals dissolved in deionized water. The concentrations of Ca++ ions in deionized water are made to be same as the normal Ca++ ions in urine, the concentration of Ca++ (0.0000093 M) remains constant while the amount of deionized water is varied from 9.300 mL to 1.800 mL; which is equivalent to 0.001 M/L to 0.005 M/L, respectively. For sample 1, the moles (M) of CaCl.2H₂O dissolved in deionized water are calculated as 0.005 g/147 gm=0.000034 M. Since the 0.000034 M is for all ions in in the solution made of CaCl.2H₂O, a mole ratio for Ca++ ions as (40/147)*0.000034=0.0000093 M is used. Given the urine equivalent Ca++ ions concentration (say 0.001. M/L=0.001 M/1000 mL) is known, then the equivalent volume of deionized water for (0.0000093) is calculated as (1000 mL*0.0000093 M)/0.001 M=9.30 mL. The same process is repeated for samples number 2 to 5. The results are depicted in Table 3.

TABLE 3
prepared urine-equivalent Calcium ions in deionized water.

| | Mass | Moles of Ca+ | Deionized water | Urine equivalent |
|---|---|---|---|---|
| Samples | (gm) | ions (M) | (mL) | (M/L) |
| 1 | 0.005 | 0.0000093 | 9.300 | 0.001 |
| 2 | 0.005 | 0.0000093 | 4.650 | 0.002 |
| 3 | 0.005 | 0.0000093 | 3.100 | 0.003 |
| 4 | 0.005 | 0.0000093 | 2.300 | 0.004 |
| 5 | 0.005 | 0.0000093 | 1.800 | 0.005 |

In FIG. 11A, the black curve is the frequency noises when the Ca++ ions concentration is 0.001 M and the measured frequency noises are 30 KHz. As the concentrations increase to 0.002 M, the measured frequency noises stabilize between 700 KHz and 1100 KHz and the frequency change, Δf, is 400 KHz. FIG. 11B shows the frequency noises measured using 0.003 M of Ca++ ions, the measured frequency noises stabilize between 1.693975 and 1.694005 MHz, the Δf is equal to 3*10⁼⁵ MHz. When the Ca++ ions concentration increases to 0.004 M, the measured frequency stabilizes between 1.693979 and 1.693989 MHz with Δf equal to 1*10⁻⁵ MHz.

FIG. 12A is a curve which shows the measured frequency noises of a solution with a low Potassium ion level from 0.003 to 0.005 M as shown in Table 4. Table 4 shows the equivalent Potassium ions concentration (K+) in clear urine prepared from deionized water. The samples are prepared from KCl crystals dissolved in deionized water. To make the concentration of K+ ions same as the normal Na+ ions in urine, the concentration of K+ is kept constant as (0.000035 M) and the amount of deionized water is varied from 11.666 mL to 5.000 mL; which is equivalent to 0.003 M/L to 0.007 M/L, respectively. For sample number 1, the moles (M) of KCl dissolved in deionized water is calculated 0.005 gm/74.55=0.000067 M. Given that the 0.000067 M is for both K+ and Cl⁻ ions in the solution, mole ratio for K⁺ ions is (39/74.55)*0.000067=0.000035 M. Given the urine equivalent K+ ions concentration (say 0.0030 M/L=0.0030 M/1000 mL), then the equivalent volume of deionized water for (0.000035) is calculated as (1000 mL*0.000035 M)/0.003 M=11.666 mL. The same process is repeated for samples number 2 to 5. The results are depicted in Table 4.

TABLE 4
prepared urine-equivalent Potassium ions in deionized water.

| | Mass | Moles of K+ | Deionized water | Urine equivalent |
|---|---|---|---|---|
| Samples | (gm) | ions (M) | (mL) | (M/L) |
| 1 | 0.005 | 0.000035 | 11.666 | 0.003 |
| 2 | 0.005 | 0.000035 | 8.750 | 0.004 |
| 3 | 0.005 | 0.000035 | 7.000 | 0.005 |
| 4 | 0.005 | 0.000035 | 5.833 | 0.006 |
| 5 | 0.005 | 0.000035 | 5.000 | 0.007 |

FIG. 12A shows that when K+ ions concentration is 0.003 M, the measured frequency noises are between 200 and 300 KHz with Δf equal to 100 KHz. As the concentrations increase to 0.004 M, the frequency noises stabilize between 700 KHz and 850 KHz with Δf equal to 150 KHz. FIG. 12B shows the frequency noises measured using higher level K+ ions, when the concentration increases to 0.006 M, the measured frequency noises stabilize between 1.693993 and 1.694006 MHz, with Δf equal to 1.3*10⁻⁵ MHz. When the K+ ions concentration increases to 0.007 M, the measured frequency stabilizes between 1.693996 and 1.694003 MHz with Δf equal to 7.0*10⁻⁶ MHz.

Table 5 shows three samples of Cardiac Troponin prepared from 200 μg diluted three times from its original open container. The vial with 200 μg is opened, filled with at least 0.2 mL of deionized water, covered and shaken for 3 minutes, the Cardiac Troponin contents are then removed and dissolved in 10 mL of deionized water and put in another container with a magnetic stirrer. The solution with Cardiac Troponin is stirred for 3 minutes and then poured into another container marked sample 1. About 0.1 mL of sample 1 was put into the probe's chamber a few seconds after stopping the magnetic stirring for frequency noise measurement before the contents in the solution precipitate or separate. The left over contents in the container with Cardiac Troponin is mixed with 0.2 mL of deionized water, shaken for 3 minutes, and then washed again with 100 mL of deionized water. The solution is then stirred using a magnetic stirrer for 3 minutes and then poured into the container marked sample 2. In less than 20 seconds, a 0.1 mL of sample 2 is poured into the probe's chamber for frequency noise measurement. The leftover of the contents of Cardiac Troponin in the original container with its container is poured into 1000 mL of deionized water and stirred for 3 minutes using a magnetic stirrer. The solution is then poured into another container labelled sample 3. A small portion (2 drops) of sample 3 is poured into 0.1 mL of the probe's chamber for frequency noise measurement.

TABLE 5
Cardiac Troponin dilution in the deionized water.

| | | | | Stirring |
|---|---|---|---|---|
| | | Dilution with | | Time |
| Samples | Mass of Cardiac Troponin | deionized water | | (minutes) |
| 1 | Full container with Troponin | 10 | mL | 3 |
| | contents | | | |
| 2 | Empty container with some | 100 | mL | 3 |
| | left over Troponin contents | | | |
| 3 | Empty container with some | 1000 | mL | 3 |
| | left over Troponin contents | | | |

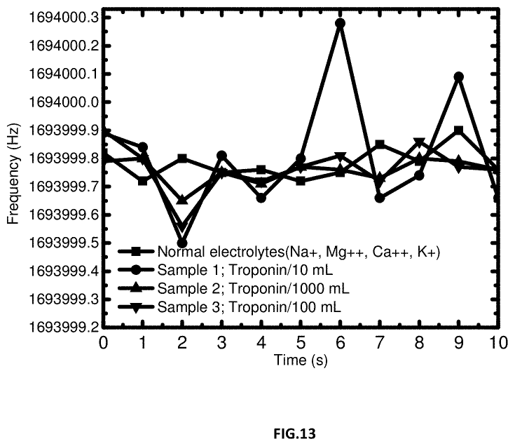

FIG. 13 is the graph with four curves showing the frequency noises of a standardized solution with normal electrolyte levels such as that seen in urine or blood: Magnesium 0.00070 M, Potassium 0.0050 M, and Calcium 0.00255 M. The concentration of Sodium is increased above the normal level (0.1550 M) in order to maintain the 10⁻¹⁰ MHz stability. The frequency noises measured of all combined electrolytes in deionized water are between 1.6939997744 and 1.6939997746 MHz; the change of frequency, Δf, between the lowest and highest frequency peaks is 2*10⁻¹⁰ MHz. Two drops from sample 1 with 10 mL of Cardiac Troponin (see Table 5) are added in a 0.1 mL of a combined electrolyte in the probe's chamber and, the measured frequency noises related to two drops from 10 mL of Cardiac Troponin solution were between 1.6939997 and 1.6940003 MHz and, the frequency change, Δf, from the lowest and the highest peaks is 3.3*10⁻⁷ MHz. When 2 drops of sample 3 with Cardiac Troponin in 1000 mL are added into a solution with 0.1 mL of calibrated electrolyte in deionized water, the measured higher and lower frequency peak noises are between 1.6939992643 and 1.6939992683 MHz and the frequency change, Δf, is 4*10⁻⁹ MHz. The final measurement is done using 2 drops from sample 2 with 0.1 mL of the solution with Cardiac Troponin dissolved in 100 mL of deionized water in the probe's chamber. The frequency noises measured are between 1.6939992572 and 1.693999683 MHz and the frequency change, Δf, is 1.11*10⁻⁸ MHz.

TABLE 6
Frequency change, Δf, versus concentration.

| Sample | Concentration | Δf (MHz) | Mass (Δm) | |
|---|---|---|---|---|
| Na+ | 0.100 M/L | 7*10⁻⁸ | 3.96*10⁻¹² | gm. |
| Na+ | 0.120 M/L | 2*10⁻⁸ | 1.13*10⁻¹² | gm |
| Na+ | 0.130 M/L | 7*10⁻⁹ | 3.9*10⁻¹³ | gm. |
| Na+ | 0.140 M/L | 3*10⁻⁹ | 1.7*10⁻¹³ | gm. |
| Na+ | 0.150 M/L | 4*10⁻¹⁰ | 2.26*10⁻¹⁴ | gm |
| Na+ | 0.155 M/L | 2*10⁻¹⁰ | 1.13*10⁻¹⁴ | gm |
| K+ | 0.003 M/L | 0.100 | 5.66*10⁻⁶ | gm |
| K+ | 0.005 M/L | 0.150 | 8.85*10⁻⁶ | gm |
| K+ | 0.006 M/L | 1.3*10⁻⁵ | 7.36*10⁻¹⁰ | gm |
| K+ | 0.007 M/L | 7.0*10⁻⁶ | 3.96*10⁻¹¹ | gm |
| Mg++ | 0.0003 M/L | 0.025 | 1.416*10⁻⁶ | gm |
| Mg++ | 0.0005 M/L | 0.050 | 2.83*10⁻⁶ | gm |
| Mg++ | 0.0007 M/L | 0.200 | 1.133*10⁻⁵ | gm |
| Mg++ | 0.0009 M/L | 2.2*10⁻⁴ | 1.24*10⁻⁸ | gm |
| Mg++ | 0.0010 M/L | 1.01*10⁻⁴ | 5.66*10⁻⁹ | gm |
| Ca++ | 0.001 M/L | 0.030 | 1.70*10⁻⁷ | gm |
| Ca++ | 0.002 M/L | 0.400 | 2.26*10⁻⁶ | gm |
| Ca++ | 0.003 M/L | 3*10⁻⁵ | 1.70*10⁻⁹ | gm |
| Ca++ | 0.004 M/L | 1*10⁻⁵ | 5.66*10⁻¹⁰ | gm |

| | | | |
|---|---|---|---|
| Cardiac Troponin in 10 mL | 3.3*10⁻⁷ | 1.87*10⁻¹¹ | gm |
| Cardiac Troponin in 100 mL | 1.1*10⁻⁸ | 6.23*10⁻¹³ | gm |
| Cardiac Troponin in 1000 mL | 4.0*10⁻⁹ | 2.268*10⁻¹³ | gm |
| Deionized water | 7.5*10⁻⁴ | 1.13*10⁻⁹ | gm |
| Ambient air | 3*10⁻¹⁰ | 16*10⁻¹⁵ | gm |
| QCM mass resolution at 1.694 MHz | — | 1.25*10⁻¹⁵ | gm |

In order to convert the measured frequency noises, Δf, shown in Table 6 to femtogram, the detectable frequency noises on the bottom electrode (with 0.4 cm radius) of QCM are assumed to be the same as the frequency applied on the ring electrode. Thus, considering the mass (m) of the electrode layer, the tiny volume (V) of the Gold layer must be known. This volume is estimated using the equation πr²t where the thickness (t) is 3*10⁻⁵ cm and the radius (r) of the bottom layer of the Gold electrode is 0.4 cm. The mass (m) of the Gold layer is then calculated by multiplying the density of Gold (ρ=19.3 gm/cm³) to the volume it occupies. Therefore, the mass of Gold electrode layer in contact with solution or air is given by multiplying πr²t*ρ=(3.14*0.4 cm*0.4 cm*3*10⁻⁵ cm)*(19.3 gm/cm³)=9.6*10⁻⁵ gm. The measured frequency shift (Δf) in the presence of air is 3*10⁻¹⁰ MHz when the applied resonant frequency (f) is 1.694 MHz. The frequency ratio (Δf/f) is 1.7*10⁻¹⁰, and the Δm due to frequency noises applied on the ring electrode and bottom brass electrode when the chamber is filled with air, is given by the expression: Δf/f*m=1.7*10⁻¹⁰*9.6*10⁻⁵ gm=16*10⁻¹⁵ gm.

The measured Δf when the chamber was filled with deionized water was 0.75 KHz and Δm is calculated using the same expression: Δf/f*m =4.4*10⁻⁴*9.6*10⁻⁵ gm=1.13*10⁻⁹ gm. The frequency noises, Δf, related to concentrations of Ca++, Mg++, and K+ ions in deionized water are between 10⁻¹ and 10⁻⁶ MHz (Table 6) showing that, the Na+ ions are the dominant electrolyte in urine or blood; because, the measured Δf for Na+ ions is between10⁻⁸ and 10⁻¹⁰ MHz. The measured Δf when the chamber is filled with 0.10M of Na+ ions was 7*10⁻⁸ MHz and the Δm was calculated using Δf/f*m=4.13*10⁻⁸*9.6*1.0⁻⁵ gm=3.96*10⁻¹² gm. When the Na+ ions concentration increases to 0.120 M, the frequency shift, Δf, is 2*10⁻⁸ MHz and the calculated Δm is f/f*m=1.18*10⁻⁸*9.6*10⁻⁵ gm=1.13*10⁻¹² gm. When the concentration of Na+ ions increases to 0.130 M the measured frequency shift, Δf, was 7*10⁻⁹ MHz and the Δm is calculated using Δf/f*m=4.13*10⁻⁹*9.6*10⁻⁵ gm=3.9*10⁻¹³ gm. When the concentration of Na+ ions is 0.140 M, the measured frequency shift, Δf, is 3*10⁻⁹ MHz and Δm is calculated as Δf/f*m=1.77*10⁻⁹*9.6*10⁻⁵ gm=1.7*10⁻¹³ gm. When the Na+ ions concentration is 0.150 M, the frequency shift, Δf, is 4*10⁻¹⁰ MHz and the Δf is calculated as Δf/f*m=2.36*10⁻¹⁰*9.6*10⁻⁵ gm=2.26*10⁻¹⁴ gm. When the Na+ concentration is increased to 0.155 M, the measured frequency noises stabilized to 2*10⁻¹⁰ MHz, and the Δm is calculated using the same expression; Δf/f*m=1.18*10⁻¹⁰*9.6*10⁻⁵ gm=1.13*10⁻¹⁴ gm.

Therefore, when the frequency change, Δf, is from 10⁻⁸ to 10⁻¹⁰ MHz, the detected concentration is related to that of normal and abnormal Na+ ions level equivalent to that seen in urine or blood. The frequency change, Δf, from 0.1 to 10⁻⁶ MHz belongs to other electrolytes (K+, Ca++, and Mg++) as shown in Table 6. The normal concentration of salt in the urine may be between 0.135 and 0.145 M/L of Na+ ions. Accordingly, the present invention detects not only abnormal salt level below 0.135 M/L but also, a higher salt level above 0.145 M/L. It also detects Cardiac Troponin in deionized water, that is, the measured frequency change, Δf, is 3.3*10⁻⁷ MHz when 2 drops of Cardiac troponin in 10 mL are added to the 0.1 mL chamber filled with the standardized electrolytes. The calculated Δm is Δf/f*m=1.94*10⁻⁷*9.6*10⁻⁵ gm=1.87*10⁻¹¹ gm. The measured frequency change, Δf, is 1.1*10⁻⁸ MHz when the 2 drops of Cardiac Troponin in 100 mL are added in 0.1 mL chamber filled with the standardized electrolytes.

The Δm is then calculated using Δf/f*m=0.649*10⁻⁸*9.6*10⁻⁵ gm=6.23*10⁻¹³ gm. The measured frequency change, Δf, is 4*10⁻⁹ MHz when the 2 drops of Cardiac Troponin in 1000 mL are added to 0.1 mL chamber filled with the standardized electrolytes. The Δm is then calculated using Δf/f*m=2.362*10⁻⁹*9.6*10⁻⁵ gm=2.268*10⁻¹³ gm. Given the results of these experiments, the present invention is 100,000 times more sensitive than the current QCM mass sensor technology and, has a mass resolution capable to measure mass from 3.76*10⁻¹⁴ to 1.25*10⁻¹⁵ gm/cm² in the air. Additionally, when 1.694 MHz is applied to a solution with 0.155 M/L of Na+ ions, the frequency noises stabilize to approximately 2*10⁻¹⁰ MHz, which is sensitive enough to detect nanoparticles suspended in the solution to 1.13*10⁻¹⁴ gm. Accordingly, the present disclosure provides a QCM mass sensor capable of detecting normal and abnormal electrolyte level, virus, bacteria, or blood Troponin level before major infection can cause cardiovascular diseases, heart failure, or neurological diseases.

While at least one exemplary embodiment has been presented in the foregoing detailed description, it should be, appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

### REFERENCES

The references listed below and all references cited herein are hereby incorporated by reference in their entireties.

(1) Bazant, M. Z.; Squires, T. M. Induced-Charge Electro-Kinetic Phenomena: Theory and Microfluidic Applications, Phys. Rev. Letters 92, 066101, 2004, 1-4.

(2) Ramos, A.; Morgan, H.; Green, N. G.; Castellanos, A. AC Electro kinetics: A Review of Forces in Microelectrode Structures. J. Phys. D: Appl. Phys. 31, 1998, 2338-2353.

(3) Ramos, A.; Morgan H.; Green, N. G.; Castellanos, A. AC Electric-Field-Induced Fluid Flow in Microelectrodes. J. Colloid Interface Sci. 217, 1999, 420-422.

(4) Green, N. G.; Ramos A.; Gonza A.; Morgan H.; Castellanos, A. Fluid Flow Induced by Non-uniform AC Electric Fields ire Electrolytes on Microelectrodes. I. Experimental Measurements. Phys. Rev. E 61, 4011, 2000, 4011-4018.

Ajdari, A. Pumping Liquids Using Asymmetric Electrode Arrays, Phys. Rev. E61, 2000, R45-R48.

(6) Green, N. G.; Ramos, A.; Gonza, A.; Morgan, H.; Castellanos, A. Fluid Flow induced by No uniform AC Electric: Fields in Electrolytes on Microelectrodes. III. Observation of Streamlines and Numerical Simulation. Phys. Rev. E66, 026305, 2002, 1-11.

(7) Studer, V.; Pepin, A.; Chen, Y.; Ajdari, A. An integrated AC Electro kinetic Pump in a Microfluidic Loop for Fast and Tunable Flow Control. Analyst, 129, 944, 2004, 944-949.

(8) Martin, Z. B.; John, P. U.; Jeremy, A. L; Kapil, S.; Mustafa, S. K.; Andrew J.; Todd, Electrolyte Dependence of AC-Electro-osmosis: http://web.mit.edu/bazant/www/ICEO/india07.pdf.

(9) Bazant, M. Z.; Kilic, M. S.; Storey, B.; Adjari, A. Nonlinear Electro kinetics at Large Applied Voltages. Advances in Colloid and Interface Science. 152, 2009, 48-88.

(10) Rangadhar, P.; Analava, M.; Soumen, D. Impedimetric Characterization of Human Blood Using Three-Electrode Based ECIS devices. Journal of Electrical Bioimpedance. 3, 2012, 12-19.

(11) Abdalla, S.; Al-ameer, S. S.; Al-Magaishi, S. H. Electrical Properties With Relaxation Through Human Blood, Biomicrofluidics, 4, 034101, 2010.

(12) Adela, B.; Richard, N. Z.; Karin, M. Inductive Behavior of Electrolytes in AC Conductance Measurements. Chemical Physics Letters, 402, 2005, 274-278.

(13). Seif, S.; Thundat, T.; Cadien, K. An Ultrasensitive AT-Cut quartz crystal microbalance femtogram mass sensor, U.S. patent Ser. No. 15/810,348 filled Nov. 13, 2017.

(14) Bensson, R. J.; Groslambert, J. M.; Wall, F. L. Quartz Crystal Resonators and Oscillators, Recent Developments and Future Trends. Ferroelectrics. 43, 1982, 57-65.

(15) Martinez, G.; Bustabad, E. A.; Perrot, H.; Gabrielli, C.; Bucur, B.; Lazerges, M.; Rose, D.; Pardo, L. R.; Farina, J.; Compere, C.; Vives, A. A.; Development of a Mass Sensitive Quartz Crystal Microbalance (QCM)-Based DNA Biosensor Using a 50 MHz Electronic Oscillator Circuit. Sensors. 11, 8, 2011, 7657-7664.

(16) Moure, M. J.; Rodiz, P.; Rodríguez-Pardo, L.; Farina, J.; An FPGA-Based System for the Measurements of Frequency Noise and Resolution of QCM Sensors. Latin American Applied Research. 37, 2007, 25-30.

(17) Arnau, A. A Review of Interface Electronic Systems for AT-cut Quartz Crystal Microbalance Applications in Liquids Sensors. 8, 1, 2008, 370-411.

(18) O'Sullivan, C. K.; Guilbault, G. G.; Commercial Quartz Crystal Microbalances—Theory and Applications. Biosensors & Bioelectronics. 14, 1999, 663-670.

(19) Handley, J. Product Review: Quartz Crystal Microbalances. Analytical Chemistry. A, 2001, 225-229.

(20) Bouzidi, L.; Narine, S. S.; Stefanov, K. G.; Slavin, A. High-Stability Quartz-Crystal Microbalance for Investigations in Surface Science. J. Rev. Sci. Instrum. 74, 2003, 3039-3044.

(21) Narine, S. S.; Slavin, A. J.; Use of the Quartz Crystal Microbalance to Measure the Mass of Submonolayer Deposits: Measuring the Stoichiometry of Surface Oxides. J. Vac. Sci. Technol. A, 16, 1998, 1859-1862.

(22) Eklud, P. C.; Goyal, A. T.; Srinivasa, A. Carbon Nanotube-Quartz Resonator with Femtogram Resolution. U.S. Pat. No. 7,814,776 B2. 2007.

(23) Allan, L. S. Mass and Heat Flow Measurement Sensor. U.S. Pat. No. 6,439,765 B2, 2002.

(24) Kannangai, R.; Abraham, A. M.; Sankar, S.; Sridharan, G. Nanotechnology Tools for Single-Virus Particle Detection. J. Med. Microbial. 28, 2, 2010, 95-99.

(25) Nader, S. J.; Sridhar, S. A Self-Sensing Piezoelectric Micro Cantilever Biosensor for Detection of Ultra Small Adsorbed Masses: Theory and Experiments Sensors, Basel. 13, 5, 2013, 6089-6108.

(26) Ono, T.; Li, X.; Miyashita, H.; Esashi, M. Ultrasensitive Nanoelectromechanical Mass Detection. Rev. Sci. Instrum. 74, 3, 2003, 4469-4471.

(27) Lavrik, N. V.; Datskos, P. G.; Femtogram Mass Detection Using Photo thermally Actuated Nano mechanical Resonators. Appl. Phys. Lett. 82, 2003, 2697-2699.

(28) Dohn, S.; Sandberg, R.; Svendsen, W.; Boisen, A. Mass and Position Determination of Attached Particles on Cantilever Based Mass Sensors. Appl. Phys. Lett. 86, 103303, 2005, 1-3

(29) Forsen, E.; Abadal, G.; Ghatnekar-Nilsson, S.; Teva, J.; Verd, J.; Sandberg, R.; Svendsen, W.; Perez-Murano, F.; Esteve, J.; Figueras, E.; Campabadal, F.; Montelius, L.; Barniol, N.; Bojsen, A. System on Chip Mass Sensor Based on Polysilicon Cantilevers Arrays for Multiple Detection. Appl. Phys. Lett. 87, 132, 2005, 154-164

(30) Ekinci, K. L.; Huang, X. M. H.; Roukes, M. L. Ultrasensitive Nanoelectromechanical Mass Detection. Appl. Phys. Lett. 84, 22, 2004, 4469-4471

(31) Ilic, B.; Craighead, H. G.; Krylov, S.; Senaratne, W.; Ober, C.; Neuzil, P. Attogram Detection Using Nanoelectromechanical Oscillators. J. Appl. Phys. 95, 2004, 3694-3703.

(32) Nishio, M.; Sawaya, Akitaa, S.; Nakayama, Y.; Carbon Nanotube Oscillators toward Zeptogram Detection. .Appl. Phys. Lett. 86, 133111, 2005, 1-3.

(33) Sazonova, V.; Yaish, Y.; Stunel, H. U.; Roundy, D.; Arias, T. A.; Paul, L. M. A Tunable Carbon Nanotube Electromechanical Oscillator. Nature. 431, 2004, 284-287.

(34) Burg, T. P.; Godin, M.; Knudsen, S. M.; Shen, W.; Carlson, G.; Foster, J. S.; Babcock, K.; Manalis, S. R. Weighing of Biomolecules, Single Cells and Single Nanoparticles in Fluid. Nature. 446, 7139, 2007, 1066-1069.

(35) Sauerbrey, G. Verwendung von Schwingquarzen zur Wägung Dünner Schichten und zur Mikrowägung. Zeitschrift für Physik, 155, 1959, 206-222.

(36) Tsionsky, V.; Daikhin, L.; Gileadi, E. Response of the Electrochemical Quartz Crystal Microbalance for Gold Electrodes in the Double-Layer Region. J. Electrochem. Soc, 143, 1996, 2240-2245.

(37) Kanazawa, K. K.; Gordon, J. G. Frequency of a Quartz Microbalance in Contact with the Liquid. Anal. Chem, 57, 1985, 1770-1771.

(38) Vig, J. R.; Walls, F. L. A Review of Sensor Sensitivity and Stability. Proceedings of 2000 IEEE/EIA International Frequency Control Symposium and Exhibition, pp. 30-32.

(39) Rodriguez-Pardo, L.; Rodríguez, J. F.; Gabrielli, C.; Perrot, H.; Brendel, R.; Sensitivity, Noise, and Resolution in QCM Sensors in Liquid Media. IEEE Sensors Journal. 5, 6, 2005, 1251-1257.

1. A process of detecting a physiological analyte with a resolution of 1.25 femtogram or more in an ionic solution comprising:
inputting a sample of the ionic solution containing an unknown quantity of the analyte into a chamber of a measurement probe system;
applying a frequency from a signal generator connected to an electrical input to a Quartz Crystal Microbalance (QCM) mass sensor, which is in contact with the sample of ionic solution within said chamber;
detecting frequency noises with a second cover;
transmitting said frequency noises from said second cover to a frequency counter via an electrical output; and
assessing the amount of the analyte present in the sample of ionic solution based on the frequency measured by said frequency counter at a resolution of 1.25 femtograms.

2. The process of claim 1 wherein said measurement probe system comprises
a housing;
said QCM mass sensor disposed within said housing at a first end of said housing;
a first cover attached to said housing at the first end of said housing;
said second cover attached to said housing at a second end of said housing;
said chamber disposed at the second end of said housing, said chamber defined between said housing, said QCM mass sensor, and said second cover;
said electrical input in electrical communication with said QCM mass sensor; and
said electrical output in electrical communication with said second cover.

3. The process of claim 2 further comprising a fluid inlet configured to deliver said ionic solution into said chamber.

4. The process of claim 2 further comprising a filter configured to filter the ionic solution in the said fluid inlet.

5. The process of claim 1 wherein said QCM mass sensor comprises a quartz substrate with a first side and a second side, a first gold layer on the first side of said substrate, a second gold layer on the said second side of said substrate, and a ring electrode on said first gold layer.

6. The process of claim 8 wherein said ring electrode is brass.

7. The process of claim 1 wherein said QCM mass sensor further comprises a first chromium adhesive layer between said first gold layer and said substrate and a second chromium adhesive layer between said second gold layer and said substrate.

8. The process of claim 1 wherein said electrical input includes a first base support, said first base support attached to said first cover.

9. The process of claim 1 wherein said electrical output includes a second base support, said second base support attached to said second cover.

10. The process of claim 1 further comprising a signal generator configured to supply an input signal to said electrical input.

11. The process of claim 1 wherein said QCM mass sensor is configured to produce a frequency based on a signal received from the said electrical input.

12. The process of claim 1 wherein said the second cover is configured to detect and transmit frequency noises to said electrical output.

13. The process of claim 2 further comprising a frequency counter configured to measure frequency noises via the said electrical output.

14. The process of claim 2 wherein said measurement probe system is configured to read frequency noises from 10⁻⁸ to 10⁻¹² MHz.

15. The process of claim 14 further comprising a signal generator and a frequency counter in a single box.

16. The process of claim 15 further comprising a Field Programmable Gate Array (FPGA).

17. The process of claim 1, where the QCM mass sensor operates at a frequency of at least 1.694 MHz.

18. The process of claim 1 wherein the analyte is suspended nanoparticles or troponin.

19. The process of claim 30 wherein the ionic solution is blood or urine.

20. The process of claim 1 wherein the frequency applied to the QCM mass sensor is 1.694 MHz.
